(19) United States
(12) Patent Application Publication
(10) Pub. No.: US 2023/0366842 A1
(43) Pub. Date: Nov. 16, 2023

(54) BUSHING WEAR MONITORING

(71) Applicant: Caterpillar Inc., Peoria, IL (US)

(72) Inventor: Eric J. JOHANNSEN, Washington, IL (US)

(73) Assignee: Caterpillar Inc., Peoria, IL (US)

(21) Appl. No.: 17/663,117

(22) Filed: May 12, 2022

(51) Int. Cl. G01N 25/72; H04W 4/80; G01N 3/06

(52) U.S. Cl. CPC G01N 25/72; H04W 4/80; G01N 3/06; B62D 55/21

(57) ABSTRACT

In some implementations, a monitoring system may include a sensor device located on an inner surface of a bushing of a track link. The sensor device may be configured to generate data indicating an amount of strain or wear experienced by a portion of the bushing. The monitoring system may include a wireless communication device communicatively coupled to the sensor device and configured to transmit information indicating the data. The monitoring system may include a controller configured to determine an amount of wear, of the portion of the bushing, based on the data, and generate wear information indicating the amount of wear.

### TECHNICAL FIELD

The present disclosure relates generally to tracked machines and, for example, to bushing wear monitoring.

### BACKGROUND

A machine, such as a tractor, a dozer, or another earth or material moving machine, may be supported on an undercarriage assembly that may include one or more continuous tracks that facilitate movement of the machine over ground surfaces. The undercarriage assembly typically also includes a drive sprocket to drive a continuous track about one or more idlers, one or more track rollers, and/or other guiding components. The continuous track includes a series of track links pivotally joined to each other by pins and/or bushings (the combination of a pin and a bushing is sometimes referred to as a “cartridge assembly”). The drive sprocket of the undercarriage assembly may engage with the bushings to drive the continuous track.

Over the course of many hours of operation, the constant abrasion and impact of the drive sprocket with the bushings can result in significant wear to the bushings. This may weaken the bushings and diminish a performance of the undercarriage assembly, result in damage to the undercarriage assembly, require substantial maintenance for the undercarriage assembly, or the like. Moreover, due to the location of the bushings in the undercarriage assembly, as well as the contact between the drive sprocket and the bushings, the bushings are difficult to access and monitor for wear.

U.S. Patent Application Publication No. 20150337522 (the '522 publication) relates to monitoring the status of machine components of a track-type mobile machine. The '522 publication describes using a sensor system on or within a machine component of a track-type mobile machine that monitors the status or a characteristic of the machine component. While the '522 patent relates to monitoring components of a track-type machine, the present disclosure relates to monitoring the wear of a bushing of a track. Moreover, the monitoring system of the present disclosure solves one or more of the problems set forth above and/or other problems in the art.

### SUMMARY

In some implementations, a monitoring system may include a sensor device located on an inner surface of a bushing of a track link. The sensor device may be configured to generate data indicating an amount of strain or wear experienced by a portion of the bushing. The monitoring system may include a wireless communication device communicatively coupled to the sensor device and configured to transmit information indicating the data. The monitoring system may include a controller configured to determine an amount of wear, of the portion of the bushing, based on the data, and generate wear information indicating the amount of wear.

In some implementations, a track link bushing may include a bushing body having an outer surface and an inner surface that defines a cavity of the bushing body, the outer surface of the bushing body including a wear surface that receives contact from a sprocket. The track link bushing may include a strain measurement device located on the inner surface of the bushing body in alignment with the wear surface, the strain measurement device configured to generate strain data indicating an amount of strain experienced by a portion of the bushing body.

In some implementations, a track link assembly includes at least one track link, a bushing engaged with the at least one track link, the bushing having an outer surface and an inner surface that defines a cavity of the bushing, a pin disposed in the cavity of the bushing, and a strain measurement device located on the inner surface of the bushing. The strain measurement device may be configured to generate strain data indicating an amount of strain experienced by a portion of the bushing.

### BRIEF DESCRIPTION OF THE DRAWINGS

FIG. 1 shows an example machine.

FIG. 2 shows a perspective view of an example track link assembly, in partial cutaway to show detail.

FIG. 3 shows a perspective view of an example track link assembly, in partial cutaway to show detail.

FIG. 4 is a diagram of an example monitoring system.

### DETAILED DESCRIPTION

This disclosure relates to a monitoring system, which is applicable to any machine that utilizes a tracked undercarriage. For example, the machine may be used for mining, construction, farming, transportation, or another industry. Moreover, one or more implements may be connected to the machine. As an example, a machine may include a construction vehicle, a work vehicle, or a similar vehicle associated with the industries described above.

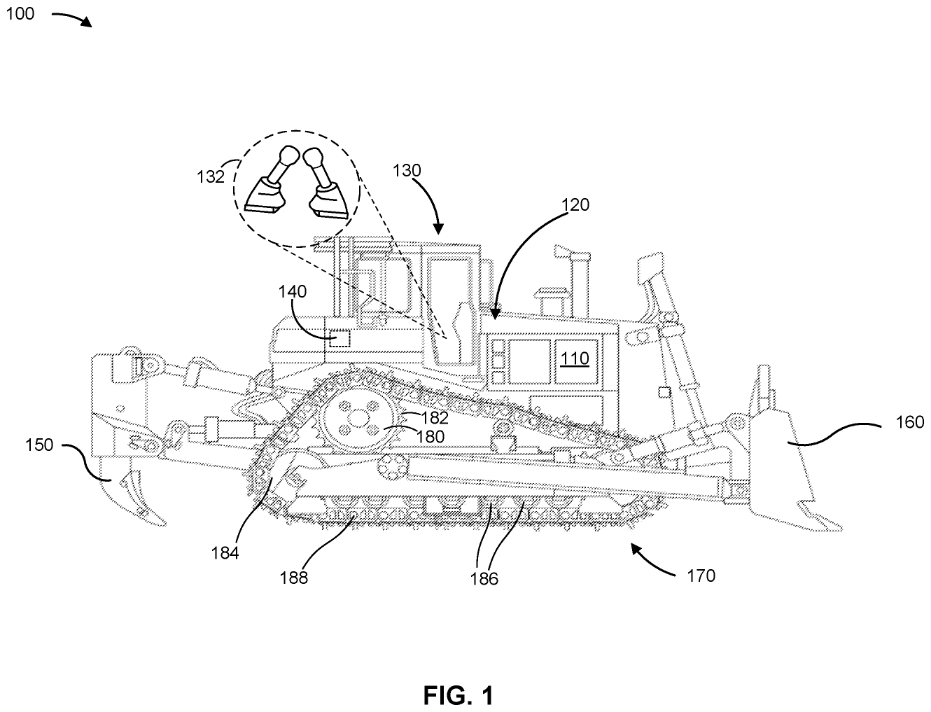

FIG. 1 shows an example machine 100. As shown in FIG. 1, machine 100 is embodied as an earth moving machine, such as a dozer. Alternatively, machine 100 may be another type of track-type machine, such as an excavator.

As shown in FIG. 1, machine 100 includes an engine 110, a sensor system 120, an operator cabin 130, operator controls 132, a machine controller 140, a rear attachment 150, a front attachment 160, track 170, sprocket 180, one or more idlers 184, one or more rollers 186, and/or sensing assemblies 188 (referred to herein individually as “sensing assembly 188,” and collectively as “sensing assemblies 188”).

Engine 110 may include an internal combustion engine, such as a compression ignition engine, a spark ignition engine, a laser ignition engine, a plasma ignition engine, or the like. Engine 110 provides power to machine 100 and/or a set of loads (e.g., components that absorb power and/or use power to operate) associated with machine 100. For example, engine 110 may provide power to one or more control systems, sensor system 120, operator cabin 130, and/or track 170.

Engine 110 can provide power to an implement of machine 100, such as an implement used in mining, construction, farming, transportation, or any other industry. For example, engine 110 may power components (e.g., one or more hydraulic pumps, one or more actuators, and/or one or more electric motors) to facilitate control of rear attachment 150 and/or front attachment 160 of machine 100.

Sensor system 120 includes sensor devices that are capable of generating signals regarding an operation of machine 100. The sensor devices, of sensor system 120, may include a vibration sensor device, a speed sensor device, or a motion sensor device, among other examples. As an example, the sensor devices may include one or more inertial measurement units (IMUS).

Operator cabin 130 includes an integrated display (not shown) and operator controls 132. Operator controls 132 may include one or more input components (e.g., integrated joysticks, push-buttons, control levers, and/or steering wheels) to control an operation of machine 100. For example, operator controls 132 may be used to control an operation of one or more implements of machine 100 (e.g., rear attachment 150 and/or front attachment 160) and/or control an operation of track 170.

For an autonomous machine, operator controls 132 may not be designed for use by an operator and, rather, may be designed to operate independently from an operator. In this case, for example, operator controls 132 may include one or more input components that provide an input signal for use by another component without any operator input.

Rear attachment 150 may include a ripper assembly, a winch assembly, and/or a drawbar assembly. Front attachment 160 may include a blade assembly. An undercarriage of machine 100 includes one or more tracks 170 configured to propel machine 100. A single track 170 is shown in FIG. 1, and machine 100 may include another track 170 on an opposite side of machine 100 (which is not shown in FIG. 1). A track 170 includes a plurality of track link assemblies, and a track link assembly may include one or more track links, as well as a bushing and a pin engaged with the track links, as described in more detail below.

Sprocket 180 may include one or more sprocket segments 182. Sprocket 180 may be configured to engage with track 170 and to drive track 170. For example, sprocket segments 182 may be configured to engage bushings of track 170 and rotate to cause track 170 to propel machine 100. Sprocket 180 may be included in a drivetrain of machine 100.

Controller 140 (e.g., an electronic control module (ECM)) may control and/or monitor operations of machine 100 (e.g., of track 170). For example, controller 140 may control and/or monitor the operations of machine 100 based on signals from operator controls 132, from sensor system 120, and/or from sensing assemblies 188. Controller 140 may determine an amount of wear of one or more bushings based on signals from sensing assemblies 188, as described in more detail below.

As indicated above, FIG. 1 is provided as an example. Other examples may differ from what was described in connection with FIG. 1.

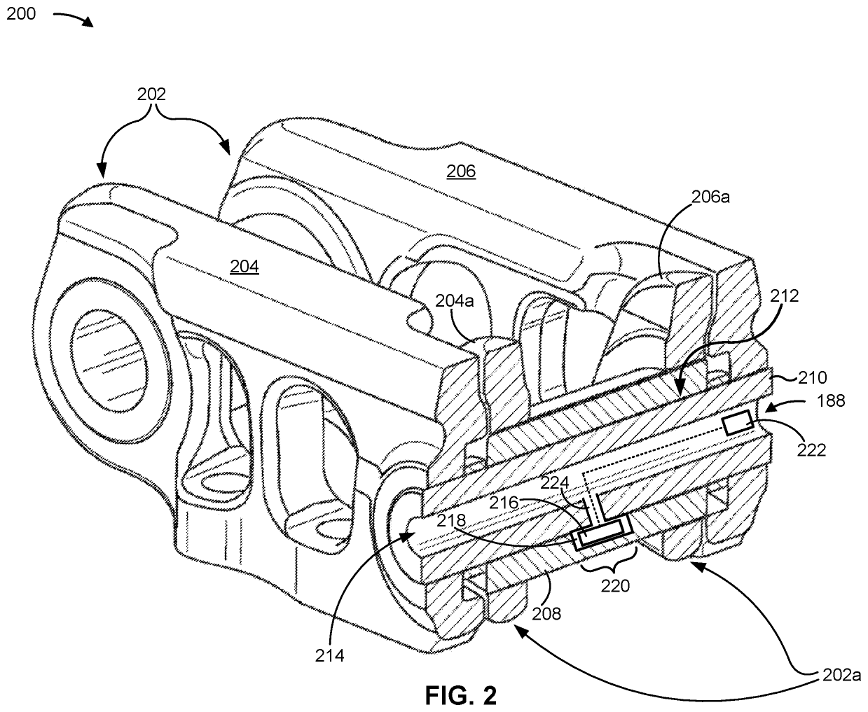

FIG. 2 shows a perspective view of an example track link assembly 200, in partial cutaway to show detail. Track link assembly 200 may be included in track 170 of machine 100. Track link assembly 200 may include a first track link set 202, and the first track link set 202 may include two track links 204, 206. Track link assembly 200 also may include other track link sets interconnected to track link set 202 in end-to-end arrangement. For example, FIG. 2 shows another track link set 202a that includes two track links 204a and 206a connected to each other, and to track link set 202, by a bushing 208 (e.g., a track link bushing) that is mounted concentrically around a pin 210. One track link set may be connected to another track link set in this same fashion until a sufficient number of track link sets are interconnected to form track 170.

Bushing 208 (e.g., a bushing body of bushing 208) may have an outer surface and an inner surface that defines a cavity 212 of bushing 208 in which pin 210 is disposed. For example, bushing 208 may have a substantially cylindrical shape with a longitudinal bore extending fully or partially therethrough. Similarly, pin 210 may have a substantially cylindrical shape with a longitudinal bore extending fully or partially therethrough. Accordingly, pin 210 also may have a cavity 214 within pin 210.

A sensor device 216, of a sensing assembly 188, may be located on the inner surface of bushing 208. For example, the inner surface of bushing 208 may have a recess 218, and sensor device 216 may be disposed in recess 218. The outer surface of bushing 208 may include a wear surface 220 that receives contact from the sprocket 180. Sensor device 216 may be located on the inner surface of bushing 208 in alignment with wear surface 220. For example, relative to a forward direction of travel of machine 100, a lateral location (e.g., from side-to-side of machine 100) of sensor device 216 may overlap with a lateral location of wear surface 220. Sensor device 216 may include, or may be connected to, a power source (not shown), such as a battery. For example, the power source may also be disposed in recess 218.

Sensor device 216 may include a strain measurement device that may include one or more devices configured to sense an amount of strain experienced by a portion of bushing 208 (e.g., a portion of bushing 208 associated with wear surface 220) and generate strain data indicating an amount of strain experienced by the portion of bushing 208. For example, the strain measurement device may include a strain gauge. The strain experienced by the portion of bushing 208 may be due to deformation of the portion of bushing 208 (e.g., associated with wear surface 220) from contact from sprocket 180. In this regard, as an amount of wear of wear surface 220 increases (e.g., due to material being worn away), the amount of strain experienced by the portion of bushing 208 may increase. Moreover, as the amount of strain increases, values of the strain data generated by the strain measurement device may increase accordingly.

Additionally, or alternatively, sensor device 216 may include one or more optical sensors and/or ultrasonic sensors. For example, an ultrasonic sensor may be configured to direct ultrasonic signals at bushing 208 (e.g., the inner surface of bushing 208 associated with wear surface 220), detect a reflection of the ultrasonic signals, and generate a signal based on the reflected ultrasonic signals. The signal based on the reflected ultrasonic signals may indicate an amount of strain (e.g., the ultrasonic sensor may be a strain measurement device) experienced by a portion of bushing 208 (e.g., a portion of bushing 208 associated with wear surface 220) and/or a thickness of the portion of bushing 208.

Additionally, or alternatively, sensor device 216 may include a wear sensing device. The wear sensing device may be configured to generate a signal indicative of an amount of wear at a portion of bushing 208 (e.g., a portion of bushing 208 associated with wear surface 220). The amount of wear may include an amount of material that has been worn away from bushing 208. The wear sensing device may include a wear portion (e.g., a wear strip) disposed on an outer surface of bushing 208 (e.g., at wear surface 220), such that as the outer surface is worn away, the wear portion also wears away. Thus, the wear sensing device may detect (e.g., by a connection to the wear portion, such as through a wall of bushing 208) a change to the wear portion (e.g., a change in a dimension, a structure, or a state of the wear portion), which can be correlated to an amount of wear at the portion of bushing 208.

Sensor device 216 may provide sensor data (or information indicating the sensor data), such as strain data, thickness data, wear data, or the like, to a wireless communication device 222 of the sensing assembly 188. Wireless communication device 222 may be co-located with sensor device 216. For example, wireless communication device 222 and sensor device 216 may be provided together on a printed circuit board. Alternatively, wireless communication device 222 may be located remotely from sensor device 216, and wireless communication device 222 and sensor device 216 may communicate via a wired connection or a wireless connection. For example, wireless communication device 222 may be located in cavity 214 of pin 210.

Pin 210 may include a bore 224 that provides fluid communication between cavity 212 of bushing 208 and cavity 214 of pin 210 (e.g., to allow lubricant to flow through bore 224). Here, sensor device 216 may be connected to wireless communication device 222 by at least one wire via bore 224, as shown (where the dashed line represents the at least one wire). In some examples, sensor device 216 may be connected to (e.g., using a wired connection) wireless communication device 222 via a slip ring (not shown). The slip ring may be located at an interface between bushing 208 and pin 210 (e.g., at an outer surface of pin 210 and/or at the inner surface of bushing 208), and sensor device 216 and wireless communication device 222 may each have a wired connection to the slip ring. For example, wireless communication device 222 may have a wired connection to the slip ring via bore 224. In some implementations, sensor device 216 may be wirelessly connected to wireless communication device 222 (e.g., using a short-range wireless communication protocol, such as Bluetooth Low-Energy (BLE), Bluetooth, Wi-Fi, near-field communication (NFC), Z-Wave, ZigBee, or Institute of Electrical and Electronics Engineers (IEEE) 802.154, among other examples).

Wireless communication device 222 may include, or may be connected to, a power source (not shown), such as a battery. For example, the power source may also be located in cavity 214 of pin 210. In some examples, this power source may also power sensor device 216, for example by a wired connection in a similar manner as described above. Wireless communication device 222 may be configured to transmit information indicating the sensor data generated by sensor device 216. For example, wireless communication device 222 may include a transmitter component and/or a receiver component configured to communicate using a short-range wireless communication protocol, as described above.

As indicated above, FIG. 2 is provided as an example. Other examples may differ from what was described in connection with FIG. 2.

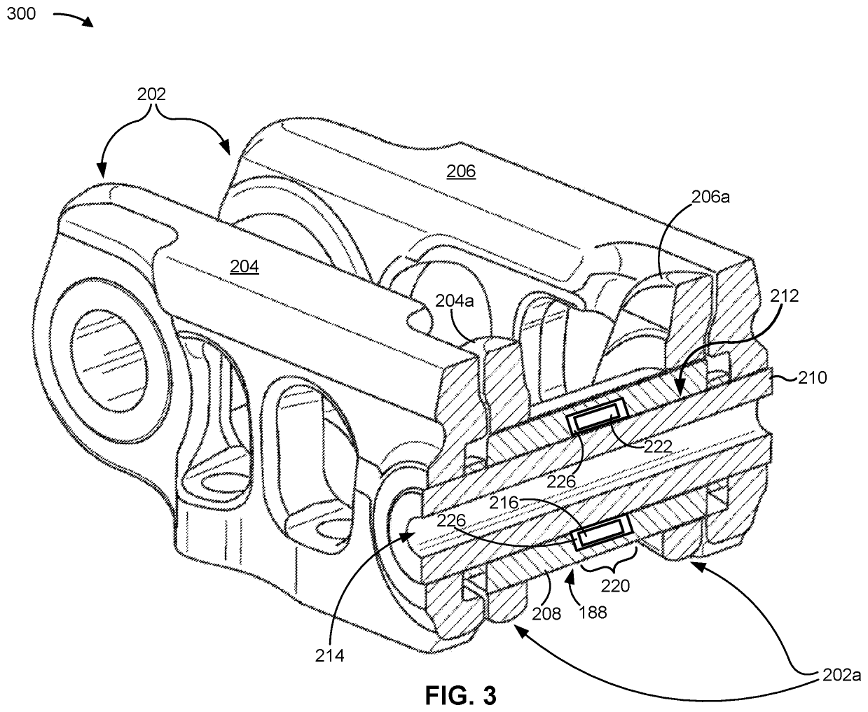

FIG. 3 shows a perspective view of an example track link assembly 300, in partial cutaway to show detail. Track link assembly 300 may be configured similarly to track link assembly 200, as described above. However, for track link assembly 300, bushing 208 may include a groove 226 that extends axially around (e.g., fully or partially) the inner surface of bushing 208. Sensor device 216 may be disposed in groove 226. For example, sensor device 216 may be disposed in groove 226 in alignment with wear surface 220, as described above. Wireless communication device 222 may also be disposed in groove 226. For example, wireless communication device 222 may be disposed in groove 226 on an opposite side of cavity 212 from sensor device 216 (e.g., in alignment with a surface of bushing 208 that is opposite wear surface 220). Here, if a wired connection between sensor device 216 and wireless communication device 222 is used, sensor device 216 may be connected to wireless communication device 222 by at least one wire that runs in cavity 212 of bushing 208 (e.g., around pin 210). In some implementations, wireless communication device 222 may be disposed on an outer surface of bushing 208 (e.g., located at the surface of bushing 208 that is opposite wear surface 220). In some implementations, groove 226, with sensor device 216 and wireless communication device 222 disposed therein, may be filled with an isolating material (e.g., using a potting technique) to isolate sensor device 216 and wireless communication device 222 from lubricant contained in cavity 212.

As indicated above, FIG. 3 is provided as an example. Other examples may differ from what was described in connection with FIG. 3.

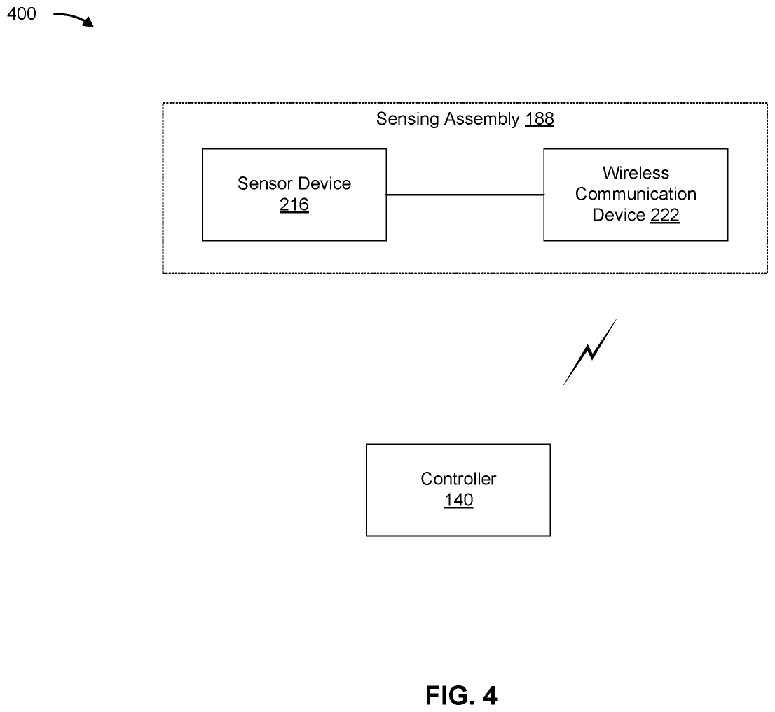

FIG. 4 is a diagram of an example monitoring system 400. Monitoring system 400 includes sensor device 216 and wireless communication device 222, of a sensing assembly 188, and controller 140. As described above, sensor device 216 and wireless communication device 222 may be communicatively coupled and may communicate via a wired connection or a wireless connection. Moreover, wireless communication device 222 and controller 140 may communicate via a wireless connection (e.g., using a short-range wireless protocol, as described above).

Controller 140 may include one or more memories, one or more processors, and/or one or more wireless communication devices. Controller 140 (e.g., the one or more processors) may be configured to perform operations associated with determining an amount of wear of bushing 208, as described herein.

Controller 140 may receive, using a wireless communication device of controller 140, the information indicating the sensor data from wireless communication device 222. For example, the information may include an analog signal indicative of the sensor data, a digital signal indicative of the sensor data, one or more values indicative of the sensor data, or the like. Controller 140 may determine an amount of wear, of the portion of bushing 208, based on the sensor data. As an example, controller 140 may determine a first amount of wear of bushing 208 based on a first value of the sensor data, determine a second amount of wear of bushing 208 based on a second value of the sensor data, and so on. The second amount of wear may exceed the first amount of wear based on the second value exceeding the first value. In some cases, controller 140 may determine the amount of wear based on strain data and with reference to a baseline strain level (e.g., based on a difference between the strain data and the baseline strain level). For example, the baseline strain level may be based on strain data generated by the strain measurement device during an initial use of machine 100 or during a use of machine 100 immediately after replacement of bushing 208. Controller 140 may also determine an estimate of a remaining useful life of bushing 208 based on the amount of wear.

Controller 140 may generate wear information indicating the amount of wear that is determined. For example, the wear information may identify a percentage by which bushing 208 is worn or may identify a wear level by which bushing 208 is worn (e.g., low wear, moderate wear, high wear, or the like), among other examples. In some examples, the wear information indicating the amount of wear may indicate the estimate of the remaining useful life of bushing 208. In some examples, the wear information indicating the amount of wear may further indicate a recommendation to repair and/or replace bushing 208.

In particular, controller 140 may compare the amount of wear and a wear threshold. Information identifying the wear threshold may be stored in the one or more memories associated with controller 140. In some situations, the wear threshold may be determined based on historical data regarding an amount of wear of a bushing 208 at a time when the bushing 208 was replaced.

In a case where the amount of wear does not satisfy the wear threshold, controller 140 may cause a notification to be provided. The notification may include information identifying bushing 208 and/or information identifying the amount of wear. The notification may be provided internally with respect to operator cabin 130, provided externally with respect to operator cabin 130, provided to a device of an operator of machine 100, and/or provided to a back office system, among other examples.

In a case where the amount of wear of the component does satisfy the wear threshold, controller 140 may cause one or more actions to be performed in addition to or alternatively to causing the notification to be provided. In this situation, the notification may indicate that bushing 208 is to be replaced and/or repaired. With respect to the one or more actions, controller 140 may cause an adjustment of an operation of machine 100 to reduce and/or prevent additional wear of bushing 208. For instance, controller 140 may reduce a speed of machine 100, may reduce the speed to bring machine 100 to a stop, and/or may immobilize machine 100, among other examples. Additionally, or alternatively, to causing the adjustment of the operation of machine 100, controller 140 may provide an instruction to the operator to adjust the operation of machine 100 in a manner similar to the manner described above. Moreover, controller 140 may generate and provide a service request to repair bushing 208 and/or to replace bushing 208.

In some examples, controller 140 may cause machine 100 to autonomously navigate to a repair facility. Additionally, or alternatively, controller 140 may cause a calendar of a technician to be populated with a calendar event to inspect, repair, and/or replace bushing 208. Additionally, or alternatively, controller 140 may cause an alarm to be activated. The alarm may indicate that bushing 208 is to be repaired or replaced.

In some implementations, controller 140 may provide a replacement request to a first autonomous device to cause the first autonomous device to deliver a replacement component to a location associated with machine 100. The location may include a current location of machine 100, a location of a work site where machine 100 performs multiple tasks, a location where machine 100 is stationed when machine 100 is not performing a task, and/or a location where machine 100 is stationed when machine 100 is undergoing repair and/or replacement. The replacement request may include information identifying the location associated with machine 100.

Additionally, or alternatively, to causing the first autonomous device to deliver the replacement component, controller 140 may provide a verification request to a second autonomous device to cause the second autonomous device to navigate to the location associated with machine 100 to verify the amount of wear of bushing 208. The verification request may include information identifying the location associated with machine 100. The second autonomous device may generate verification information, based on verifying the wear information, and may transmit the verification information to controller 140.

In some situations, the wear information may enable controller 140 to track bushing 208. For example, based on the wear information, controller 140 may determine when bushing 208 was installed on machine 100 and/or when bushing 208 has been replaced on machine 100.

In some implementations, a back office system (e.g., that is remotely located with respect to machine 100) may perform actions similar to the actions described above in connection with controller 140. For example, the back office system may receive the wear information from controller 140 and/or from sensing assembly 188. Alternatively, the back office system may determine the wear information in a manner similar to the manner described above in connection with controller 140 determining the wear information. Based on the wear information, the back office system may perform actions similar to the actions described above in connection with controller 140.

As indicated above, FIG. 4 is provided as an example. Other examples may differ from what was described in connection with FIG. 4.

### INDUSTRIAL APPLICABILITY

A sensing assembly described herein may be used in a track of an undercarriage of a machine. In particular, the sensing assembly may be used in a bushing and/or a pin of the track. Accordingly, the sensing assembly may be useful for any machine with a tracked undercarriage to facilitate monitoring an amount of wear of a bushing.

Implementations described herein resolve issues associated with inaccurate manual measurements and incorrect predictions regarding an amount wear of a bushing of a machine. The wear information, determined based on sensor data, may be more accurate than manual measurements and information regarding estimated useful life of the bushing. As a result of the improved accuracy, the bushing may be repaired or replaced when a repair or a replacement of the bushing is needed (as opposed to the bushing being repaired or replaced prematurely).

Additionally, as a result of the improved accuracy, implementations herein may help to reduce a possibility of failure of the bushing prior to repair and/or replacement of the bushing. Additionally, as a result of the improved accuracy, devices described herein may preserve computing and/or machine resources that would have otherwise been used to remedy issues associated with inaccurate predictions of the amount of wear of the bushing (e.g., premature failure of the bushing, premature repair of the bushing, and/or premature replacement of the bushing).

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “front,” “rear,” “forward,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A monitoring system, comprising:
a sensor device located on an inner surface of a bushing of a track link, the sensor device configured to generate data indicating an amount of strain or wear experienced by a portion of the bushing;
a wireless communication device communicatively coupled to the sensor device and configured to transmit information indicating the data; and
a controller configured to:
determine an amount of wear, of the portion of the bushing, based on the data; and
generate wear information indicating the amount of wear.

2. The monitoring system of claim 1, wherein the wireless communication device is located in a cavity of a pin disposed in a cavity of the bushing.

3. The monitoring system of claim 2, wherein the sensor device is connected to the wireless communication device by at least one wire via a bore in the pin that provides fluid communication between the cavity of the bushing and the cavity of the pin.

4. The monitoring system of claim 1, wherein the sensor device and the wireless communication device are disposed in a groove that extends around the inner surface of the bushing.

5. The monitoring system of claim 1, wherein the sensor device includes a wear portion disposed on an outer surface of the bushing, the wear portion configured to wear away as the outer surface wears away.

6. The monitoring system of claim 1, wherein the sensor device is disposed in a recess in the inner surface of the bushing.

7. The monitoring system of claim 1, wherein the wear information indicating the amount of wear indicates an estimate of a remaining useful life of the bushing.

8. The monitoring system of claim 1, wherein the wear information indicating the amount of wear indicates a recommendation to repair or replace the bushing.

9. The monitoring system of claim 1, wherein the controller is further configured to:
receive, using another wireless communication device, the information indicating the data from the wireless communication device.

10. A track link bushing, comprising:
a bushing body having an outer surface and an inner surface that defines a cavity of the bushing body,
the outer surface of the bushing body including a wear surface that receives contact from a sprocket; and
a strain measurement device located on the inner surface of the bushing body in alignment with the wear surface,
the strain measurement device configured to generate strain data indicating an amount of strain experienced by a portion of the bushing body.

11. The track link bushing of claim 10, wherein the inner surface of the bushing body has a recess, and
wherein the strain measurement device is disposed in the recess.

12. The track link bushing of claim 10, wherein the outer surface of the bushing body includes a wear surface that receives contact from a sprocket, and
wherein the strain measurement device is located on the inner surface of the bushing body in alignment with the wear surface.

13. The track link bushing of claim 10, wherein the amount of strain, experienced by the portion of the bushing body, increases as an amount of wear, of the wear surface, increases.

14. A track link assembly, comprising:
at least one track link;
a bushing engaged with the at least one track link, the bushing having an outer surface and an inner surface that defines a cavity of the bushing;
a pin disposed in the cavity of the bushing; and
a strain measurement device located on the inner surface of the bushing, the strain measurement device configured to generate strain data indicating an amount of strain experienced by a portion of the bushing.

15. The track link assembly of claim 14, further comprising:
a wireless communication device communicatively coupled to the strain measurement device and configured to transmit information indicating the strain data.

16. The track link assembly of claim 15, wherein the pin has a cavity, and
wherein the wireless communication device is located in the cavity of the pin.

17. The track link assembly of claim 16, wherein the strain measurement device is connected to the wireless communication device by at least one wire via a bore in the pin that provides fluid communication between the cavity of the bushing and the cavity of the pin.

18. The track link assembly of claim 16, wherein the strain measurement device is connected to the wireless communication device via a slip ring.

19. The track link assembly of claim 14, wherein the inner surface of the bushing has a recess, and
wherein the strain measurement device is disposed in the recess.

20. The track link assembly of claim 14, wherein the outer surface of the bushing includes a wear surface that receives contact from a sprocket, and
wherein the strain measurement device is located on the inner surface of the bushing in alignment with the wear surface.
